(19) United States
(12) Patent Application Publication
(10) Pub. No.: US 2008/0175207 A1
(43) Pub. Date: Jul. 24, 2008

(54) Wireless network for personal computer human interface devices

(75) Inventors: Kah Yong Lee, Singapore (SG); Ping Soon Kwok, Singapore (SG); Tai Chew Tan, Singapore (SG); Chee Oei Chan, Singapore (SG)

Correspondence Address: STEPHEN ACKERMAN;George O. Saile and Assocs., 28 Davis Ave., Poughkeepsie, NY, 12603, US

(73) Assignee: FreeSystems Pte., Ltd.

(21) Appl. No.: 12/006,942

(22) Filed: Jan. 8, 2008

Related U.S. Application Data
(60) Provisional application No. 60/879,174, filed on Jan. 8, 2007.
(60) Provisional application No. 60/879,172, filed on Jan. 8, 2007.
(60) Provisional application No. 60/879,173, filed on Jan. 8, 2007.

(51) Int. Cl. H04B 7/212

(52) U.S. Cl. 370/337

(57) ABSTRACT

A wireless network system includes a wireless master control hub in communication with a personal computer and provides a control protocol to human interface devices for communication to request and receive command messages, control messages, and data from the personal computer. Slave human interface devices controllers are associated with one of the human interface devices to provide translation of command or data information from the associated human interface device to the wireless control hub. The wireless control hub generates a synchronization signal to allow any of the human interface devices to permit communication between each of the human interface devices and the wireless control hub. The wireless control hub generates a receiving and transmitting time slot assignment signal for each of the human interface devices for a communication frame for communicating file requests and data between the personal computer and the human interface devices.

This application claims priority under 35 U.S.C. §119 to U.S. Provisional Patent Application Ser. No. 60/879,174, Filing Date: Jan. 8, 2007 which is herein incorporated by reference in its entirety.

### RELATED PATENT APPLICATIONS

“A Multi-Node Media Content Relay System”, Number Ser. No. 60/879,172, Filing Date: Jan. 8, 2007, assigned to the same assignee as this invention and incorporated herein by reference in its entirety.

“A Multi-Node Media Content Distribution System”, Number Ser. No. 60/879,173, Filing Date: Jan. 8, 2007, assigned to the same assignee as this invention and incorporated herein by reference in its entirety.

### BACKGROUND OF THE INVENTION

1. Field of the Invention

This invention relates generally to a networking of computer devices. More particularly, this invention relates to the wireless networking of personal computers with human interface devices in communication with the personal computer.

2. Description of Related Art

Wireless networks such as the Bluetooth network allow the communication between portable and remote electronic devices, such as notebook computers, mobile phones, personal digital assistants (PDA's), digital cameras, and mp3/MD/DVD players. Digital media content files such as digitized audio (music and voice) and video files are transferred between the portable and remote electronic devices.

“Bluetooth: An Enabler for Personal Area Networking”, Johansson, et al., IEEE Network, September/October 2001, Vol.: 15, Issue: 5, pp.: 28-37, describes use of portable electronic devices in a network of personal devices that is often referred to as a personal area network. The Bluetooth piconet network architecture, a strict star topology, is extended into a scatternet architecture, where piconets are interconnected. A consequence of creating scatternet-based personal area networks is that some nodes will form gateways between piconets, and these gateways must be capable of time sharing their presence in each piconet of which they are members. Johansson et al. presents an overall architecture for handling scheduling in a scatternet. A family of feasible inter-piconet scheduling algorithms, referred to as rendezvous point algorithms, is also introduced and discussed.

Bluetooth Human Interface Device (Hid) Profile Version 1.0 Adopted, Ranta et al., May 2003, Bluetooth SIG, found Feb. 2, 2007 at http://www.bluetooth.com, defines the protocols, procedures, and features used by Bluetooth Human Interface Devices, such as keyboards, pointing devices, gaming devices, and remote monitoring devices. Section 4.4 describes that Bluetooth Human Interface devices shall set no limitation on the number of devices per host (up to the seven simultaneous active devices allowed per piconet). All trusted devices (devices that have either been authenticated or have no security procedures required) shall be allowed to have simultaneous connections to the host, if the host so desires.

European Patent EP1391805 (Lochner, et al.) relates to a human interface device for transmitting data to and receiving data from at least one data processing unit wherein the device comprises a human interface device module, a wireless communication module and a cable communication module. Data communication connections between the modules are switchable so as to vary an operating mode of the device. The device may be a keyboard communicating with a computer system (32) via a universal serial bus (USB) connection and also communicating with other devices via a wireless communication link.

European Patent EP1455272 (Zhang, et al.) describes host-side wireless interface services communications between a wireless user input device and a serviced host. The host-side wireless interface includes a wireless network interface and a host interface. The wireless network interface wirelessly communicates with the wireless user input device. The host interface communicatively couples to the wireless interface and to the serviced host.

European Patent EP1553729 (Nick, et al.) provides a computer-readable portable media device used for transferring network settings for an ad hoc wireless network to simplify the task of configuring devices for the ad hoc wireless network. A configuration program on an initiating computer assists a user in creating the network settings, including a security key, and incorporates the network settings in an extensible markup language (XML) file and writes the file in to the portable media device. The portable media device is then attached to a second device that is to join the ad hoc wireless network. The second device is automatically configured using the network settings on the portable media device for joining the ad hoc wireless network.

U.S. Patent Application 2005/0232190 (Karaoguz, et al.) illustrates a wireless processing device, a user input device, a display, and a wireless interface identifies a plurality of wirelessly networked devices that are wirelessly networked with the wireless processing device. The wireless processing device identifies at least one of a user input devices and a display of the plurality of wirelessly networked devices that are available for use by the subject wireless device, selects from its native user input device and its native display and those user input devices and displays of plurality of wirelessly networked devices that are available. The wireless processing device receives user input via the selected user input device by the processing resources of the wireless processing device, processes the user input, and displays the output on the selected display.

U.S. Patent Application 2006/0094461 (Hameed, et al.) describes a dual mode human interface device that includes a wireless interface for wireless communication with a host computer; a wired interface for wired communication with the host computer. A processor is coupled with the wireless interface and the wired interface for transferring data between the human interface device and the host computer. The processor initiates establishing wireless communication with the host computer, when the human interface device is connected to the host computer via the wired interface.

### SUMMARY OF THE INVENTION

An object of this invention is to provide a wireless network system for communication between a personal computer system and human interface devices such as a remote control, a keyboard, a mouse, a joystick, Musical Instrument Digital Interface (MIDI) device, a headset, an internet world wide web enabled camera, a voice over internet protocol (VoIP) telephone, a VoIP video telephone, a stereo headphone, or other human operated peripheral device.

Another object of this invention is to provide a computer system having a wireless network system for communication between a computer processing unit and human interface devices.

To accomplish at least one of these objects, a wireless network system includes a wireless control hub and a plurality of slave human interface device controllers. The wireless control hub is in communication with the personal computer to act as a master node for the wireless network system. As the master node of the wireless network system, the wireless control hub provides a control protocol such that each of the human interface devices can communicate with the personal computer to request and receive command messages, control messages, and data from the personal computer. Each of the slave human interface device controllers is associated with one of the human interface devices to provide translation of command or data information that is transferred to and received from the associated human interface device for communication with the wireless control hub. The control protocol transmits a plurality of communication frames between the wireless control hub and each of the human interface devices with a Time Division Multiple Access (TDMA) protocol for communication and control between the universal wireless control hub and each of the human interface devices.

The wireless control hub generates a synchronization signal to allow any of the human interface devices to be synchronized with the wireless network system to permit communication between each of the slave human interface device controllers and the wireless control hub. Further, the wireless control hub generates a time slot assignment signal for each of the human interface devices designating a receiving time slot and a transmitting time slot of the communication frame for communicating file requests and data between the personal computer and the human interface devices. The communication frame comprises synchronization, data error detection and/or correction, and data packets for the communication of the file requests and data between the personal computer and the human interface devices.

In another embodiment, a computer system includes a computer processing unit, a plurality of human interface, and a wireless network system for communication between the plurality of human interface devices and computer processing unit. The wireless network system includes a wireless control hub and a plurality of slave human interface device controllers. The wireless control hub is in communication with the computer processing system to act as a master node for the wireless network system. As the master node of the wireless network system, the wireless control hub provides a control protocol such that each of the human interface devices can communicate with the computer processing unit to request and receive command messages, control messages, and data from the computer processing unit. Each of the slave human interface device controllers is associated with one of the human interface devices to provide translation of command or data information that is transferred to and received from the associated human interface device for communication with the wireless control hub. The control protocol transmits a plurality of communication frames between the wireless control hub and each of the human interface devices with a Time Division Multiple Access (TDMA) protocol for communication and control between the universal wireless control hub and each of the human interface devices.

The wireless control hub generates a synchronization signal to allow any of the human interface devices to be synchronized with the wireless network system to permit communication between each of the slave human interface device controllers and the wireless control hub. Further, the wireless control hub generates a time slot assignment signal for each of the human interface devices designating a receiving time slot and a transmitting time slot of the communication frame for communicating file requests and data between the computer processing unit and the human interface devices. The communication frame comprises synchronization, data error detection and/or correction, and data packets for the communication of the file requests and data between the personal computer and the human interface devices.

In various embodiments, a method for communication of command and data between a personal computer and a human interface device begins by transmitting a marker beacon from a wireless master control hub at a fixed interval to synchronize a plurality human interface devices to form a network of human interface devices. Each of the plurality of human interface devices includes a human interface device controller that is a slave to the master wireless control hub, which is in communication with a personal computer. The marker beacon is detected by each of the slave peripheral human interface device controllers. Each of the slave peripheral human interface device controllers communicates with the master wireless control hub to establish membership in the network of human interface devices.

The method continues by determining whether multiple human interface devices are trying to establish their membership on the network simultaneously, by the master wireless control hub. When multiple human interface devices are trying to establish their membership on the network, the multiple human interface devices retry to establish their membership in the wireless network at separate random times. The slave human interface devices detect the marker beacon and synchronize with the master wireless control hub at the separate random times.

The master wireless control hub assigns a transmission and reception time slot within data frames of a communication protocol to each of the network of human interface devices, when there are no collisions of the peripheral slave multiple human interface devices. Each of the peripheral slave human interface devices and the personal computer through the master wireless control hub communicate to exchange commands, requests, and data between. The communication protocol comprises of synchronization, data error detection and/or correction, and data packets for the communication of the file requests and data between the personal computer and the human interface devices.

### BRIEF DESCRIPTION OF THE DRAWINGS

FIG. 1 is a block diagram of the human interface device wireless network of this invention.

FIG. 3 is a diagram of a communication protocol of the human interface wireless network of this invention.

FIG. 4 is a flow diagram of the method for communication of command and data between a personal computer and a human interface device.

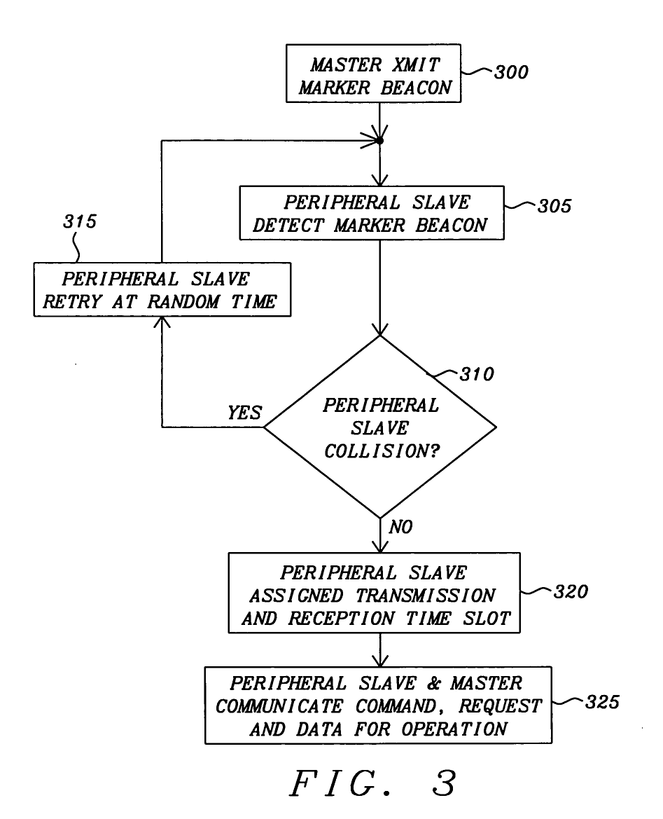

### DETAILED DESCRIPTION OF THE INVENTION

A wireless network for personal computer human interface devices of this invention provides communication with all the human interface devices for a personal computer such as a remote control, a keyboard, a mouse, a joystick, Musical Instrument Digital Interface (MIDI) device, a headset, an internet world wide web enabled camera, a voice over internet protocol (VoIP) telephone, a VoIP video telephone, a stereo headphone, or other human operated peripheral device.

The universal wireless control hub of the wireless network for personal computer human interface devices of this invention connects to a personal computer via a personal computer such as a Universal Serial Bus (USB), Personal Computer Memory Card International Association (PCMCIA) or any other physical interface. Alternatively, the universal wireless control hub can be built onto the motherboard of the personal computer.

The wireless network for personal computer human interface devices of this invention uses radio frequency (RF) to communicate between the devices and the personal computer. The universal wireless control hub acts as a master node and the human interface devices communicating with the personal computer act as slave devices for the wireless network. The protocol employs a Time Division Multiple Access (TDMA) protocol for the communication and control of the universal wireless control hub and the human interface devices. The universal wireless control hub provides a beacon or marker for each of the human interface devices to synchronize with the wireless network. Each of the human interface devices are assigned a time slot of a communication frame for receiving command, control and data from the personal computer through universal wireless control hub and a time slot of the communication from for transmitting file requests and data to the personal computer through the universal wireless control hub. The communication frame provides the necessary synchronization, data error detection and/or correction, and the data packets for the communication.

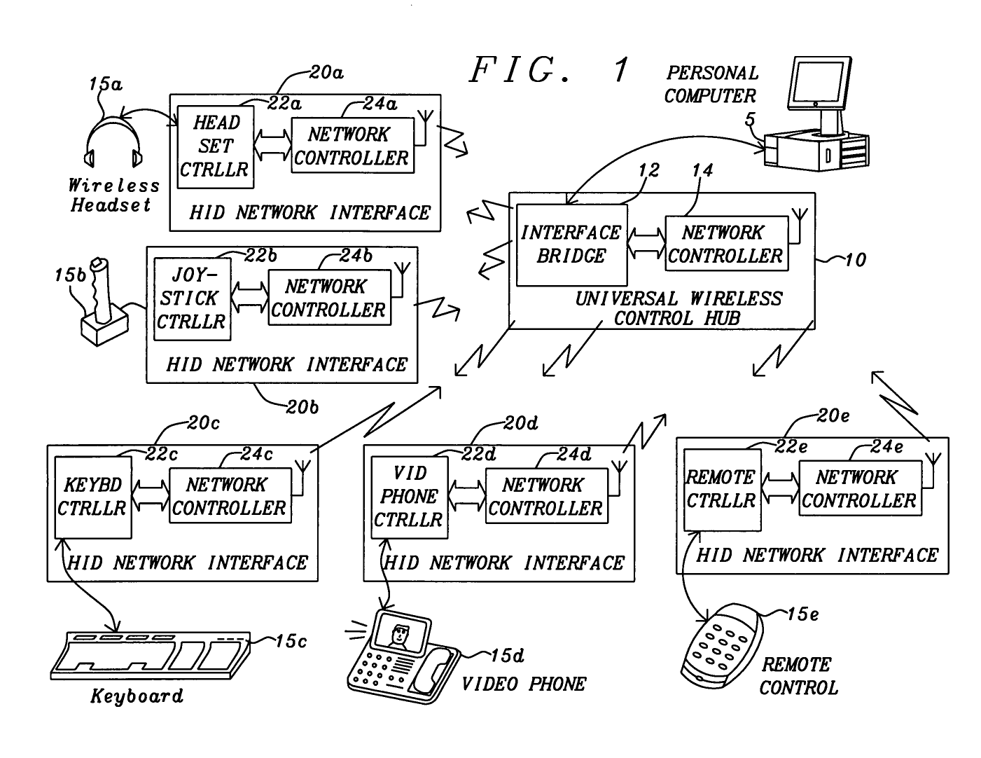

Refer now to FIG. 1 for a more detailed description of the wireless network for personal computer human interface devices of this invention. The personal computer 5 has a universal wireless control hub 10 either plugged into an interface connector such as a USB connector or a PCMCIA connector or integrated into system packing of the personal computer 5. The universal wireless control hub 10 has an interface bridge that converts the command and data that is transmitted to or received from the human interface devices 15a, 15b, 15c, 15d, and 15e the necessary format for use by the personal computer 5. The network controller 14 receives or sends the command and data information from or to the interface bridge 12, formats the command or data information for transmission or extract the received data command or data information.

Each of the human interface devices 15a, 15b, 15c, 15d, and 15e is in communication with a human interface device network 20a, 20b, 20c, 20d, and 20e. Each human interface device network interface 20a, 20b, 20c, 20d, and 20e has a human interface device controller 22a, 22b, 22c, 22d, and 22e to provide the necessary translation of the command or data information that is transferred to and received from the human interface device 15a, 15b, 15c, 15d, and 15e. The human interface device controller 22a, 22b, 22c, 22d, and 22e is in communication with the network controller 24a, 24b, 24c, 24d, and 24e to transfer to or receive the command or data information.

A wireless headset 15a receives digitized audio signals from the personal computer 5 through the universal wireless control hub 10 and the human interface device network interface 20a and transmits requests for digitized audio signals to personal computer 5 through the universal wireless control hub 10 and the human interface device network interface 20a. A joystick 15b transmits digitized stick movement signals to personal computer 5 through the universal wireless control hub 10 and the human interface device network interface 20b. A Keyboard 15c transmits digitized keystroke signals to the personal computer 5 through the universal wireless control hub 10 and the human interface device network interface 20c. A video telephone 15d transmits and receives digitized video and audio signals to and from the personal computer 5 through the universal wireless control hub 10 and the human interface device network interface 20d. A remote control device 15e transmits digitized command and request signals to the personal computer 5 through the universal wireless control hub 10 and the human interface device network interface 20e and a receives status and command signals from the personal computer 5 through the universal wireless control hub 10 and the human interface device network interface 20e.

The network controller 14 of the universal wireless control hub 10 and the human interface device controllers 22a, 22b, 22c, 22d, and 22e of the human interface device network interfaces 20a, 20b, 20c, 20d, and 20e provide a protocol that is able to support simultaneous transmission and reception from human interface devices 15a, 15b, 15c, 15d, and 15e. The universal wireless control hub 10 is the master whereas the human interface device network interfaces 20a, 20b, 20c, 20d, and 20e are the slaves. The universal wireless control hub 10 acting as the master will transmit a marker (or beacon) at a fixed interval in order to synchronize the human interface device network interfaces 20a, 20b, 20c, 20d, and 20e as slaves. Each human interface device network interface 20a, 20b, 20c, 20d, and 20e as slave is given a dedicated time slot for data transmission and reception between the universal wireless control hub 10 as master and the human interface device network interfaces 20a, 20b, 20c, 20d, and 20e as slaves. The human interface device network interfaces 20a, 20b, 20c, 20d, and 20e as slaves will communicate to the universal wireless control hub 10 as master directly and there is no communications among the human interface device network interfaces 20a, 20b, 20c, 20d, and 20e.

Inter-device interference is avoided by using time division multiple access (TDMA) mechanism for the communication between the universal wireless control hub 10 and the human interface device network interfaces 20a, 20b, 20c, 20d, and 20e. The universal wireless control hub 10 allocates a time slot for transmission & reception for each of the human interface device network interfaces 20a, 20b, 20c, 20d, and 20e. In the case of collision during device discovery and initialization, a random back-off and retry mechanism will be used.

Refer now to FIG. 2 for an overview of the basic structure of the protocol for the communication between the universal wireless control hub 10 and the human interface device network interfaces 20a, 20b, 20c, 20d, and 20e. Each data frame 100 is divided into multiple time slots 105a, 105b, . . . , 105n. The beginning of the data frame 100 contains a frame synchronization pattern 110 that is transmitted by the universal wireless control hub 10 to provide the marker or beacon for the human interface devices 15a, 15b, 15c, 15d, and 15e to access the network through their human interface device network interfaces 20a, 20b, 20c, 20d, and 20e human interface device network interfaces 20a, 20b, 20c, 20d, and 20e. Once the network controllers 24a, 24b, 24c, 24d, and 24e of the human interface device network interfaces 20a, 20b, 20c, 20d, and 20e have established synchronization, they communicate with the universal wireless control hub 10 to request a transmit and receive time slot 105a, 105b, . . . , 105n. The universal wireless control hub 10 assigns the time slots 105a, 105b, . . . , 105n such that each of the human interface devices 15a, 15b, 15c, 15d, and 15e have their assigned transmit and receive time slots 105a, 105b, . . . , 105n During a transmit time slots 115a and 115b, the human interface devices 15a, 15b, 15c, 15d, and 15e transmit their request, commands and data to the universal wireless control hub 10 and then to the personal computer 5. During the receive slots 115n the human interface devices 15a, 15b, 15c, 15d, and 15e receive their commands and data from the universal wireless control hub 10 and then to the personal computer 5.

The sub-frames 105 of the data frame 100 are divided into three sections: a header 115, a data package 120, and a trailer 125. The header 115 provides a synchronization pattern 116 for the sub-frame 115, a start signal 117 indicating a beginning of the transmission, a transmit identifier 118 indicating the source device and a receiver identifier 119 indicating the receiving device. The data package 120 contains command packets 121 which contain command or requests for the personal computer 5 or the human interface devices 15a, 15b, 15c, 15d, and 15e. The data packets 122 which contains the data such as digitized audio or digitized video for the personal computer 5 or the human interface devices 15a, 15b, 15c, 15d, and 15e. The trailer 125 is the ending segment that may contain just a stop signal or include error detection and correction data or other data frame 100 control information.

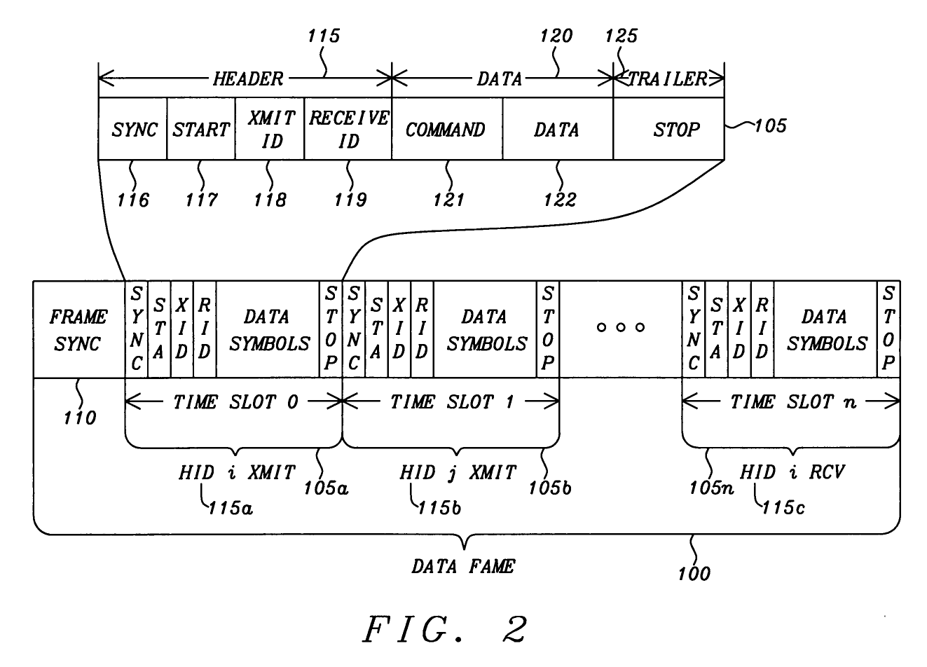

FIG. 3 illustrates a method for communication of command and data between a personal computer and a human interface device of this invention. The wireless control hub acting as a master node transmits (Box 300) a marker beacon at a fixed interval in order to synchronize human interface device network interface of human interface device as a peripheral slave to the master wireless control hub of a personal computer. The peripheral slave of the human interface device detects (Box 305) the marker beacon and communicates with the master wireless control hub to establish membership in the network. The master wireless control hub determines (Box 310) whether multiple human interface devices are trying to establish their membership on the network. If multiple human interface devices are trying to establish their membership on the network, the multiple human interface devices retry to establish their membership at separate random times, each of the multiple human interface devices detect (Box 305) the marker beacon and synchronize with the master wireless control hub at their separate times. If there are not collisions of the peripheral slave multiple human interface devices, the master wireless control hub is assigned (Box 320) its transmission and reception time slot within the data frames of the communication protocol. The peripheral slave human interface devices communicate (Box 325) with the master wireless control hub to exchange commands, requests, and data.

While this invention has been particularly shown and described with reference to the preferred embodiments thereof, it will be understood by those skilled in the art that various changes in form and details may be made without departing from the spirit and scope of the invention.

The invention claimed is:

1. A wireless network system for communication between a plurality of human interface devices and a personal computer: comprising:
a wireless control hub in communication with the personal computer to act as a master node for the wireless network system to provide a control protocol such that each of the human interface devices can communicate with the personal computer to request and receive command messages, control messages, and data from the personal computer; and
a plurality of slave human interface device controllers, wherein each of the slave human interface device controllers is associated with one of the human interface devices to provide translation of command or data information that is transferred to and received from the associated human interface device for communication with the wireless control hub;
wherein the control protocol transmits a plurality of communication frames between the wireless control hub and each of the human interface devices with a Time Division Multiple Access (TDMA) protocol for communication and control between the universal wireless control hub and each of the human interface devices.

2. The wireless network system of claim 1 wherein the wireless control hub generates a synchronization signal to allow any of the human interface devices to be synchronized with the wireless network system to permit communication between each of the slave human interface device controllers and the wireless control hub.

3. The wireless network system of claim 1 wherein the wireless control hub generates a time slot assignment signal for each of the human interface devices designating a receiving time slot and a transmitting time slot of the communication frame for communicating file requests and data between the personal computer and the human interface devices.

4. The wireless network system of claim 1 wherein the communication frame comprises synchronization, data error detection and/or correction, and data packets for the communication of the file requests and data between the personal computer and the human interface devices.

5. The wireless network system of claim 1 wherein each one of the human interface devices is a remote control, a keyboard, a mouse, a joystick, Musical Instrument Digital Interface (MIDI) device, a headset, an internet world wide web enabled camera, a voice over internet protocol (VoIP) telephone, a VoIP video telephone, a stereo headphone, or other human operated peripheral device.

6. A computer system comprising:
a computer processing unit;
a plurality of human interface;
a wireless network system for communication between the plurality of human interface devices and computer processing unit: comprising:
a wireless control hub in communication with the personal computer to act as a master node for the wireless network system to provide a control protocol such that each of the human interface devices can communicate with the personal computer to request and receive command messages, control messages, and data from the personal computer; and
a plurality of slave human interface device controllers, wherein each of the slave human interface device controllers is associated with one of the human interface devices to provide translation of command or data information that is transferred to and received from the associated human interface device for communication with the wireless control hub;
wherein the control protocol transmits a plurality of communication frames between the wireless control hub and each of the human interface devices with a Time Division Multiple Access (TDMA) protocol for communication and control between the universal wireless control hub and each of the human interface devices.

7. The computer system of claim 6 wherein the wireless control hub generates a synchronization signal to allow any of the human interface devices to be synchronized with the wireless network system to permit communication between each of the slave human interface device controllers and the wireless control hub.

8. The computer system of claim 6 wherein the wireless control hub generates a time slot assignment signal for each of the human interface devices designating a receiving time slot and a transmitting time slot of the communication frame for communicating file requests and data between the personal computer and the human interface devices.

9. The computer system of claim 6 wherein the communication frame comprises synchronization, data error detection and/or correction, and data packets for the communication of the file requests and data between the personal computer and the human interface devices.

10. The computer system of claim 6 wherein each one of the human interface devices is a remote control, a keyboard, a mouse, a joystick, Musical Instrument Digital Interface (MIDI) device, a headset, an internet world wide web enabled camera, a voice over internet protocol (VoIP) telephone, a VoIP video telephone, a stereo headphone, or other human operated peripheral device.

11. A method for communication of command and data between a personal computer and a human interface device comprises the steps of:
transmitting a marker beacon from a wireless master control hub at a fixed interval to synchronize a plurality human interface devices to form a network of human interface device controllers where each of the plurality of human interface device controllers are a slave peripheral to the master wireless control hub in communication with a personal computer;
detecting the marker beacon by each of the slave peripheral human interface device controller;
communicating with the master wireless control hub by each of the slave peripheral human interface device controllers to establish membership in the network of human interface device controllers;
determining whether multiple human interface device controllers are trying to establish their membership on the network simultaneously, by the master wireless control hub;
retrying by the multiple human interface device controllers to establish their membership at separate random times, when multiple human interface device controllers are trying to establish their membership on the network;
detecting the marker beacon and synchronizing with the master wireless control hub at the separate random times each of the multiple human interface device controllers;
assigning by the master wireless control hub a transmission and reception time slot within data frames of a communication protocol to each of the network of human interface device controllers, when there are no collisions of the slave peripheral multiple human interface device controllers; and
communicating to exchange commands, requests, and data between each of the slave peripheral human interface devices and the personal computer through the master wireless control hub.

12. The method for communication of command and data of claim 11 wherein the communication protocol comprises synchronization, data error detection and/or correction, and data packets for the communication of the file requests and data between the personal computer and the human interface devices.

13. The method for communication of command and data of claim 11 wherein each one of the human interface devices is a remote control, a keyboard, a mouse, a joystick, Musical Instrument Digital Interface (MIDI) device, a headset, an internet world wide web enabled camera, a voice over internet protocol (VoIP) telephone, a VoIP video telephone, a stereo headphone, or other human operated peripheral device.
